(19) United States
(12) Patent Application Publication
(10) Pub. No.: US 2015/0133609 A1
(43) Pub. Date: May 14, 2015

(54) NON-FOULING CONDUCTING POLYMERS

(71) Applicant: University of Washington through its Center for Commercialization, Seattle, WA (US)

(72) Inventors: Shaoyi Jiang, Redmond, WA (US); Tao Bai, Seattle, WA (US)

(73) Assignee: University of Washington through its Center for Commercialization, Seattle, WA (US)

(21) Appl. No.: 14/539,886

(22) Filed: Nov. 12, 2014

Related U.S. Application Data
(60) Provisional application No. 61/903,289, filed on Nov. 12, 2013.

(51) Int. Cl. C08G 73/02

(52) U.S. Cl. CPC C08G 73/026
USPC 525/435; 528/331; 525/420

(57) ABSTRACT

Zwitterionic and mixed charge conducting polymers, surfaces modified to include the polymers, bulk constructs that include the polymers, and methods for using the polymers.

Therefore, there is a need to investigate the utility of such polymers in bioengineering applications, and a need to develop polymers that can interact with biological molecules, such as proteins and cells, for preparation of improved biointerfaces.

### SUMMARY OF THE INVENTION

In one aspect, the invention provides non-fouling conducting polymers.

In one embodiment, the invention provides a zwitterionic polymer having repeating units, the repeating units comprising a repeating unit selected from

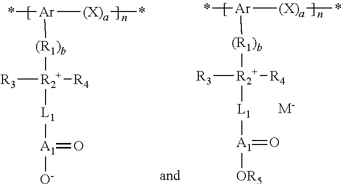

wherein

* is the point of attachment of one repeating unit and the next,

—[Ar—(X)ₐ]ₙ— forms the polymer backbone,

Ar is selected from arylene, substituted arylene, heteroarylene, substituted heteroarylene, alkenylene, substituted alkylene, and alkynylene,

X is selected from S, O, N, NH, CH═CH, and C6-C12 arylene,

a is 0 or 1,

b is 0 or 1,

n is an integer from 5 to about 10,000,

R₁ is C1-C6 substituted or unsubstituted alkylene,

R₂ is a cationic site,

R₃, R₄, and R₅ are independently selected from the group consisting of hydrogen, C1-C6 alkyl, substituted C1-C6 alkyl, C6-C12 aryl, and substituted C6-C12 aryl,

L₁ is —(CH₂)ₓ—, where x is an integer from 1 to 20,

A₁ is C, S, SO, P, or PO⁻, and

M is a counter ion.

In certain embodiments, a is 1 and X is NH.

In certain embodiments, b is 0.

In certain embodiments, b is 1 and R₁ is methylene.

In certain embodiments, the cationic site is selected from ammonium, imidazolium, triazolium, pyridinium, and morpholinium. In certain embodiments, R₂, R₃, and R₄ taken together are selected from —NH₂⁺—, —NH(CH₃)⁺— and —N(CH₃)₂⁺—.

In certain embodiments, x is 1-5.

In certain embodiments, A₁ is C.

In another embodiment, the invention provides a mixed charge copolymer having repeating units, the repeating units comprising a repeating unit selected from

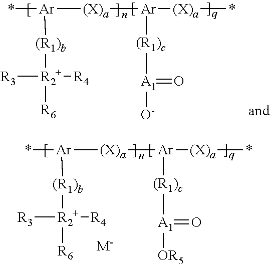

wherein

* is the point of attachment of one repeating unit and the next,

—[Ar—(X)ₐ]ₙ— forms the polymer backbone,

Ar is selected from arylene, substituted arylene, heteroarylene, substituted heteroarylene, alkenylene, substituted alkylene, and alkynylene,

X is selected from S, O, N, NH, CH═CH, and C6-C12 arylene,

a is 0 or 1,

b is 0 or 1,

c is 0 or 1,

n is an integer from 5 to about 10,000,

q is an integer from 5 to about 10,000,

R₁ at each occurrence is selected from C1-C6 substituted or unsubstituted alkylene,

R₂ is a cationic site,

R₃, R₄, R₅, and R₆ are independently selected from the group consisting of hydrogen, C1-C6 alkyl, substituted C1-C6 alkyl, C6-C12 aryl, and substituted C6-C12 aryl,

A₁ is C, S, SO, P, or PO⁻, and

M is a counter ion.

In certain embodiments, a is 1 and X is NH.

In certain embodiments, b is 0.

In certain embodiments, b is 1 and R₁ is methylene.

In certain embodiments, the cationic site is selected from ammonium, imidazolium, triazolium, pyridinium, and morpholinium. In certain embodiments, R₂, R₃, and R₄ taken together are selected from —NH₂⁺—, —NH(CH₃)⁺— and —N(CH₃)₂⁺—.

In certain embodiments, A₁ is C.

In certain embodiments, c is 0.

In certain embodiments, c is 1 and R₁ is methylene.

In another aspect, the invention provides modified surfaces. In one embodiment, the modified surface includes a non-fouling conducting polymer of the invention. In one embodiment, the modified surface is coated with the polymer and the entire surface is modified. In another embodiment, the modified surface is only a portion of the entire surface.

The surface can be the surface of a medical, electronic, or marine device, or a portion of a surface thereof. Representative surfaces include the surface of artificial neural system, neuron-regeneration platform, neural sensor, cell-culture platform; non-fouling semi-conductor, battery, organic solar cell, biofuel cell, printed electronic circuit, organic light-emitting diode, actuator, electrochromism device, supercapacitor, chemical sensor, flexible transparent display, electromagnetic shield, antistatic coating, microwave-absorbent device, or radar-absorptive device.

In a further aspect, the invention provides a bulk construct. In one embodiment, the bulk construct includes a non-fouling conducting polymer of the invention.

The bulk construct can be medical, electronic, or marine device, or a portion thereof. Representative bulk constructs include constructs of an artificial neural system, neuron-regeneration platform, neural sensor, cell-culture platform; non-fouling semi-conductor, battery, organic solar cell, biofuel cell, printed electronic circuit, organic light-emitting diode, actuator, electrochromism device, supercapacitor, chemical sensor, flexible transparent display, electromagnetic shield, antistatic coating, microwave-absorbent device, or radar-absorptive device.

In another aspect of the invention, compounds (i.e., monomers) useful for preparing the polymers of the invention are provided.

In one embodiment, the compounds have the formula:

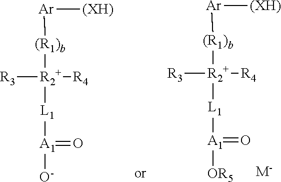

wherein

Ar is selected from arylene, substituted arylene, heteroarylene, substituted heteroarylene, alkenylene, substituted alkylene, and alkynylene,

X is selected from S, O, NH, —C≡C—, and C6-C12 arylene,

R₁ is C1-C6 alkylene,

b is 0 or 1, R₂ is a cationic center,

R₃, R₄, and R₅ are independently selected from the group consisting of hydrogen, C1-C6 alkyl, substituted C1-C6 alkyl, C6-C12 aryl, and substituted C6-C12 aryl,

L₁ is —(CH₂)ₓ—, where x is an integer from 1 to 20,

A₁ is C, S, SO, P, or PO⁻, and

M is a counter ion.

In certain embodiments, a is 1 and X is NH.

In certain embodiments, b is 0.

In certain embodiments, b is 1 and R₁ is methylene.

In certain embodiments, the cationic site is selected from ammonium, imidazolium, triazolium, pyridinium, and morpholinium. In certain embodiments, R₂, R₃, and R₄ taken together are selected from —NH₂⁺—, —NH(CH₃)⁺— and —N(CH₃)₂⁺—.

In certain embodiments, x is 1-5.

In certain embodiments, A₁ is C.

In another aspect, the invention provides a method for depositing a non-fouling conductive polymer coating on a surface. In one embodiment, the method includes

(a) dissolving a monomer that is a precursor of a polymer of the invention in an aqueous medium to form a monomer solution;

(b) contacting the monomer solution with a surface; and

(c) polymerizing the monomers to form a non-fouling conducting polymer coating on the surface.

In certain embodiments, the monomer is a monomer of the invention.

In a further aspect, the invention provides a method for making a bulk polymer construct. In one embodiment, the method includes

(a) dissolving a monomer that is a precursor of a polymer of the invention in an aqueous medium to form a monomer solution;

(b) contacting the monomer solution with a surface;

(c) polymerizing the monomers to form a bulk functionalized conducting polymer; and

(d) removing the bulk polymer from the surface to provide a bulk polymer construct.

In certain embodiments, the monomer is a monomer of the invention.

### DESCRIPTION OF THE DRAWINGS

The foregoing aspects and many of the attendant advantages of this invention will become more readily appreciated as the same become better understood by reference to the following detailed description, when taken in conjunction with the accompanying drawings.

FIGS. 1A and 1B illustrate self-doping (1A) and dedoping (1B) of PANI-CB.

FIG. 2 compares conductivity of three polymers: PANI, HCl-doped PANI, and PANI-CB, a representative polymer of the invention.

FIG. 3 compares protein adsorption on surfaces treated with PANI and PANI-CBI (bovine serum albumin (BSA), fibrinogen (FNG), fibronectin (FN), lysozyme (LYZ) and 10% fetal bovine serum (FBS)).

### DETAILED DESCRIPTION OF THE INVENTION

The invention provides functionalized conducting polymers, methods for their preparation and their use in the preparation of interfaces having regions with non-adhesive (non-fouling) surfaces.

Functionalized Conducting Polymers

In one aspect, the invention provides conducting polymers functionalized to charged groups that impart non-adhesive properties to surfaces modified with polymers. The functionalized conducting polymer has the combined advantageous properties of being electron conducting and non-fouling (e.g., non-biofouling, non-adhesive).

In certain embodiments, the conducting polymers are functionalized with zwitterionic groups (i.e., pendant zwitterionic groups). In certain of these embodiments, the zwitterionic conducting polymers include repeating units selected from repeating units having the following formulae:

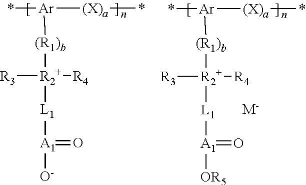

wherein

—Ar—(X)ₐ— forms the conducting polymer backbone,

* is the point of attachment of one repeating unit and the next,

Ar is selected from arylene, substituted arylene, heteroarylene, substituted heteroarylene, alkenylene, substituted alkenylene, and alkynylene,

X is selected from S, O, N, NH, CH═CH, and C6-C12 arylene,

a is 0 or 1,

n is the number of repeating units in the polymer, an integer from 5 to about 10,000,

R₁ is C1-C6 alkylene,

b is 0 or 1,

R₂ is a cationic center (e.g., ammonium, imidazolium, triazolium, pyridinium, and morpholinium), R₃, R₄, and R₅ are independently selected from the group consisting of hydrogen, C1-C6 alkyl, substituted C1-C6 alkyl (e.g., trifluoromethyl), C6-C12 aryl, and substituted C6-C12 aryl,

L₁ is —(CH₂)ₓ—, where x is an integer from 1 to 20,

A₁ is C, S, SO, P, or PO⁻, and

M is a counter ion (e.g., Cl, Br, I, SO₄, NO₃, ClO₄, BF₄, PF₆, N(SO₂CF₃)₂, SO₃CF₃, RCOO (where R is C1-C20 alkyl), lactate, benzoate, salicylate, or derivatives thereof).

In other embodiments, the conducting polymers are functionalized with mixed charge groups (i.e., substantially equal numbers of pendant cationic groups and pendant anionic groups to provide a substantially electronically neutral polymer). In certain of these embodiments, the mixed charge conducting polymers include repeating units selected from repeating units having the following formulae:

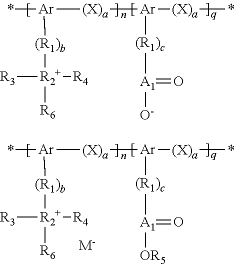

wherein Ar, X, R₁-R₅, A1, a, b, n, M, and * are as described above for the zwitterionic conducting polymers; R₆ is selected from the group consisting of hydrogen, C1-C6 alkyl, substituted C1-C6 alkyl, C6-C12 aryl, and substituted C6-C12 aryl; c is 0 or 1; and q is an integer from 5 to about 10,000.

The invention provides functionalized conducting polymers (i.e., non-fouling conducting polymers) that combine intrinsically conducting moieties (e.g., repeating units) and non-fouling zwitterionic or mixed charge moieties (e.g., repeating units).

In certain embodiments, the invention provides homopolymers of zwitterionic conducting monomers or hydrolysable precursors of zwitterionic conducting monomers. In other embodiments, the invention provides copolymers of mixed charged conducting monomers or hydrolysable precursors of mixed charged conducting monomers. As used herein, the term “hydrolysable precursors” refers to groups that after polymerization may be hydrolyzed to provide either a zwitterionic polymer or a mixed charge polymer.

The invention provides zwitterionic conducting polymer compositions that include: (a) homopolymers of zwitterionic conducting monomers or hydrolysable precursors of zwitterionic conducting monomers; (b) copolymers of mixed charged conducting monomers or hydrolysable precursors of mixed charged conducting monomers; and (c) copolymers of zwitterionic conducting monomers or hydrolysable precursors of zwitterionic conducting monomers, and mixed charged conducting monomers or hydrolysable precursors of mixed charged conducting monomers.

The polymers of the invention also include copolymers that further include repeating units that are neither zwitterionic nor mixed charge repeating units.

In certain embodiments, the polymers of the invention include only zwitterionic repeating units (e.g., zwitterionic homopolymer). In other embodiments, the polymers of the invention include zwitterionic repeating units and other repeating units that are not zwitterionic repeating units (e.g., zwitterionic copolymer).

In certain embodiments, the polymers of the invention include only mixed charge repeating units. In other embodiments, the polymers of the invention include mixed charge repeating units and other repeating units that are not mixed charge repeating units.

In certain embodiments, the polymers of the invention include only zwitterionic repeating units and mixed charge repeating units. In other embodiments, the polymers of the invention include zwitterionic repeating units, mixed charge repeating units, and other repeating units that are not zwitterionic repeating units or mixed charge repeating units.

Suitable repeating units that are neither zwitterionic groups nor mixed charge repeating units include conducting repeating units, as described herein, that provide conducting polymers.

The functionalized conducting polymers can be prepared from conducting polymers known in the art. The conducting polymers can be prepared by polymerization of corresponding functionalized monomers. Representative conducting polymers are selected from polyacetylenes, polyfurans, polythiophenes, polypyrroles, poly(heteroaromatic vinylenes), poly(3,4-ethylenedioxythiophenes), polyparaphenylenes, polyphenylene sulfides, polyanilines, and polyphenylene vinylenes. The monomers for making these polymers are known in the art and can be readily functionalized to provide suitable monomers.

In the conducting polymers, the zwitterionic moieties are selected from carboxybetaines, sulfobetaines, phosphobetaines, and other zwitterionic compounds.

In the conducting polymers, the mixed charged monomers can be selected from polymerizable monomers with positively charged cationic moieties and negatively charged anionic moieties. Representative cationic moieties are selected from quaternary ammonium, imidazolium, triazolium, pyridinium, morpholinium and other cationic moieties. Representative anionic moieties of polymerizable anionic monomers selected from hydrophilic and/or hydrophobic anions, their mixtures, or modified hydrophilic and/or hydrophobic anions thereof.

In one embodiment, the functionalized conducting polymer is a polymer that includes repeating units selected from repeating units having the following formulae:

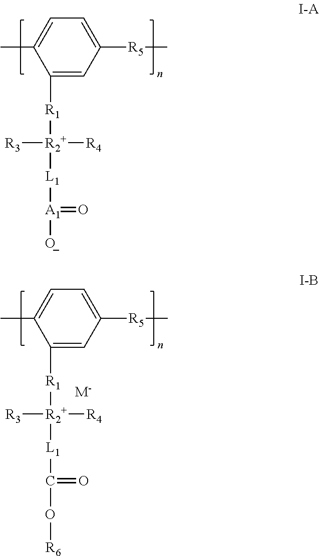

wherein

R₁ is optional and when present is selected from C1-C6 alkylene;

R₃, R₄, and R₆ are independently selected from the group consisting of hydrogen, trifluoromethyl, C1-C6 alkyl, and C6-C12 aryl groups;

R₂ is a cationic site, for example, each R₂ is independently selected from the group consisting of ammonium, imidazolium, triazolium, pyridinium, morpholinium, and other cationic groups;

R₅ is independently selected from the group consisting of S, O, N, NH, CH═CH, C6-C12 arylene.

L₁ is —(CH₂)ₓ—, where x is an integer from 1 to 20

A₁ is C, S, SO, P, or PO⁻;

M is a counter ion, for example, Cl, Br, I, SO₄, NO₃, ClO₄, BF₄, PF₆, N(SO₂CF₃)₂, SO₃CF₃, RCOO (where R is C1-C20 alkyl), lactate, benzoate, salicylate, and derivatives thereof; and

n is an integer from 5 to about 10,000.

In another embodiment, the functionalized conducting polymer is a polymer that includes repeating units selected from repeating units having the following formulae:

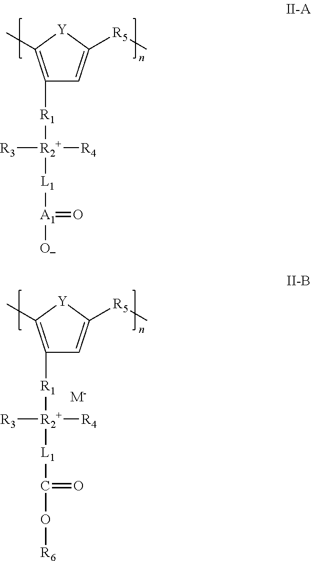

wherein R₁-R₆, L₁, A₁, M, and n are as described above and Y is selected from NH, S, O, or NR₇ where R₇ is independently selected from the group consisting of hydrogen, trifluoromethyl, C1-C6 alkyl, and C6-C12 aryl groups.

In a further embodiment, the functionalized conducting polymer is a polymer that includes repeating units selected from repeating units having the following formulae:

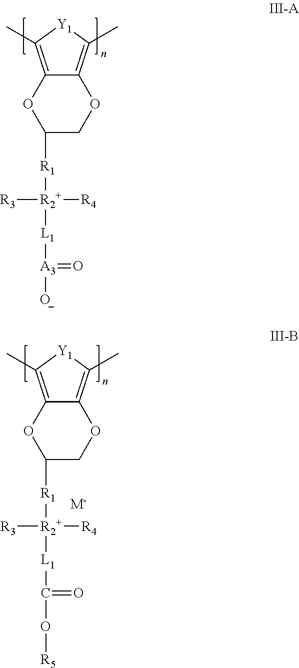

wherein R₁-R₄, L₁, M, and n are as described above, A₃ is A₁ and Y₁ is Y as described above, and R₅ is selected from the group consisting of hydrogen, trifluoromethyl, C1-C6 alkyl, and C6-C12 aryl groups.

WO 2009/054814 describes polymers having the following structure:

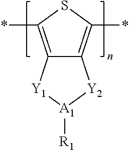

wherein

A₁ is a bridging alkylene chain, optionally substituted having 2, 3, 4, 5, or 6 carbon atoms;

Y₁ and Y₂ are independently selected from 0, S, or NR₂, wherein R₂ is hydrogen, an alkyl group an alkenyl group, an alkynyl group, a cycloalkyl group, an aryl group or a heterocycle;

R₁ is a functional chain (which may be, for example, cationic, anionic, or zwitterionic) attached to the bridging alkylene chain; and

n is an integer of 2 or more,

as described at page 12, line 26 through page 19, line 13 of WO 2009/054814, expressly incorporated herein by reference in its entirety for the purpose of identifying these polymer and related monomer species. The polymers and monomers disclosed in WO 2009/054814 are excluded from the scope of the claimed inventions.

In another embodiment, the functionalized conducting polymer is a polymer that includes repeating units selected from repeating units having the following formulae:

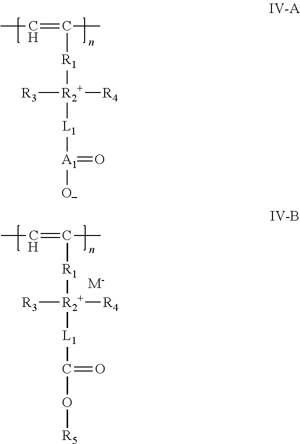

wherein R₁-R₄, L₁, M, and n are as described above, and R₅ is selected from the group consisting of hydrogen, trifluoromethyl, C1-C6 alkyl, and C6-C12 aryl groups.

In another embodiment, the functionalized conducting polymer is a copolymer that includes repeating units selected from repeating units having the following formulae:

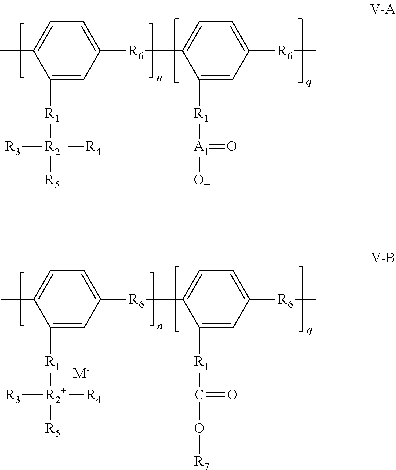

wherein

R₁ is optional and when present is selected from C1-C6 alkylene;

R₃, R₄, R₅, and R₇ are independently selected from the group consisting of hydrogen, trifluoromethyl, C1-C6 alkyl, and C6-C12 aryl groups;

R₂ is independently selected from the group consisting of ammonium, imidazolium, triazolium, pyridinium, morpholinium, and other cationic groups;

R₆ is independently selected from the group consisting of S, O, N, NH, CH═CH, C6-C12 arylene;

A₁ is C, S, SO, P, or PO⁻;

M is a counter ion, for example, Cl, Br, I, SO₄, NO₃, ClO₄, BF₄, PF₆, N(SO₂CF₃)₂, SO₃CF₃, RCOO (where R is C1-C20 alkyl), lactate, benzoate, salicylate, and derivatives thereof;

n is an integer from 5 to about 10,000; and

q is an integer from 5 to about 10,000.

In another embodiment, the functionalized conducting polymer is a copolymer that includes repeating units selected from repeating units having the following formulae:

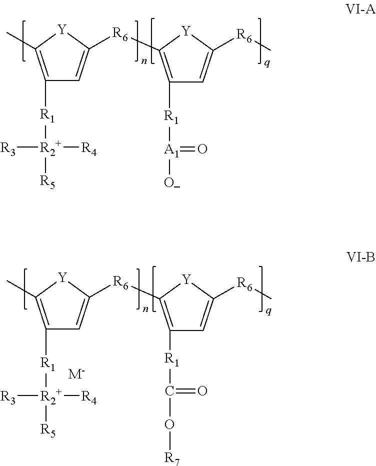

wherein R₁-R₇, A₁, M, Y, and n, and q are as described above for formulae V-A and V-B.

In another embodiment, the functionalized conducting polymer is a copolymer that includes repeating units selected from repeating units having the following formulae:

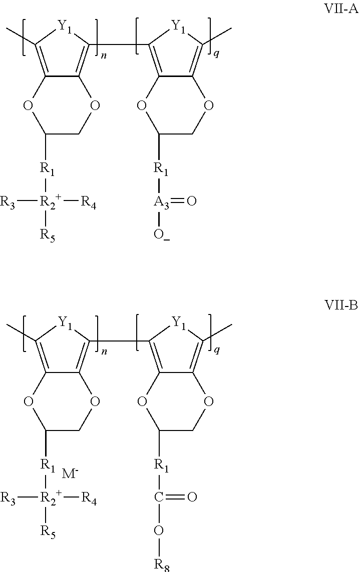

wherein R₁-R₅, M, Y₁, A₃, and n are as described above for III-A and III-B; R₆ is selected from the group consisting of hydrogen, trifluoromethyl, C1-C6 alkyl, and C6-C12 aryl groups; and q is an integer from 5 to about 10,000.

In another embodiment, the functionalized conducting polymer is a copolymer that includes repeating units selected from repeating units having the following formulae:

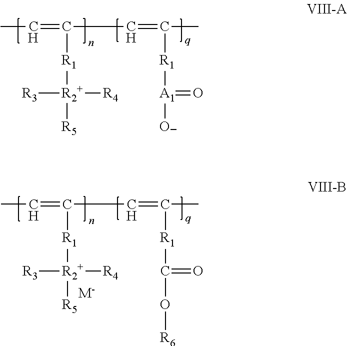

wherein R₁-R₅, M, A₁, n, and q are as described above for V-A and V-B; and R₆ is selected from the group consisting of hydrogen, trifluoromethyl, C1-C6 alkyl, and C6-C12 aryl groups.

In further embodiments, the functionalized conducting polymer is a copolymer that includes zwitterionic repeating units (e.g., one or more repeating units of formulae I-A, I-B, II-A, II-B, III-A, III-B, IV-A, and IV-B) and mixed charge repeating units (e.g., one or more repeating units of formulae V-A, V-B, VI-A, VI-B, VII-A, VII-B, VIII-A, and VIII-B).

As noted above, in certain embodiments, the polymers of the invention also include copolymers that further include repeating units that are neither zwitterionic nor mixed charge repeating units. Accordingly, in addition to polymers including only the repeating groups noted above (i.e., repeating units of formulae I-A, I-B, II-A, II-B, III-A, III-B, IV-A, IV-B, V-A, V-B, VI-A, VI-B, VII-A, VII-B, VIII-A, and VIII-B), the invention provides polymers that include these repeating units in addition to other repeating units that are neither zwitterionic repeating units nor mixed charge repeating units, as described above.

Functionalized Conducting Polymer—Modified Surfaces

In a further aspect of the invention, surfaces modified to include the functionalized conducting polymers are provided. In certain embodiments, the surfaces modified to include the functionalized conducting polymers have a surface coating comprising the functionalized conducting polymer. When the surfaces of the invention are employed in biological systems the polymer modified surfaces have non-adhesive properties.

Suitable surfaces include major surfaces as well as the surfaces of particles (e.g., colloidal silica, polystyrene beads, metal oxide particles) and fibers (e.g., nylon, cellulose). Suitable major surfaces include medical device, electronic, and marine surfaces. The polymers can be utilized in regenerative medicine, such as artificial neural system, neuron-regeneration platforms, neural sensors, and cell-culture platforms; non-fouling semi-conductors, such as batteries; organic solar cells; biofuel cells; printed electronic circuits; organic light-emitting diodes; actuators; electrochromism applications; supercapacitors; chemical sensors; flexible transparent displays; electromagnetic shielding; antistatic coatings; microwave-absorbent devices; and radar-absorptive devices.

In a related aspect, the invention provides a method of depositing functionalized conducting polymers as coatings on surfaces (e.g., non-conductive support matrices or conductive support surfaces). In certain embodiments, the coating is carried out by oxidative chemical polymerization.

In certain embodiments, the polymerization is carried out in the presence of a surface and provides a polymer-modified (e.g., polymer-coated) surface.

In other embodiments, the polymers are pre-formed and then applied to a surface to provide a polymer-modified (e.g., polymer-coated) surface.

In one embodiment, the invention provides a method for depositing a functionalized conducting polymer coating on a surface, comprising dissolving a monomer that is a precursor of a functionalized conducting polymer in an aqueous medium to form a monomer solution; contacting the monomer solution with a surface; and polymerizing the monomers to form a functionalized conducting polymer coating on the surface.

Functionalized Conducting Polymer—Bulk Constructs

In another aspect of the invention, bulk constructs that include the functionalized conducting polymers are provided. As used herein, the term “bulk construct” refers to a construct (e.g., device or substrate) formed from the functionalized conducting polymer. Bulk constructs of the invention differ from modified surfaces of the invention in that bulk constructs are not prepared by modifying a surface with a functionalized conducting polymer of the invention. Methods for making bulk constructs from polymer are known in the art. The functionalized conducting polymers of the invention can be used in those methods.

Suitable bulk constructs include particles and fibers. Suitable bulk constructs include those useful in medical device, electronic, and marine constructs. The polymers can be utilized bulk constructs for regenerative medicine, such as artificial neural system, neuron-regeneration platforms, neural sensors, and cell-culture platforms; non-fouling semi-conductors, such as batteries; organic solar cells; biofuel cells; printed electronic circuits; organic light-emitting diodes; actuators; electrochromism applications; supercapacitors; chemical sensors; flexible transparent displays; electromagnetic shielding; antistatic coatings; microwave-absorbent devices; and radar-absorptive devices.

Monomers for Making Functionalized Conducting Polymers

In another aspect, the invention provides monomers for making the functionalized conducting polymers described herein.

In certain embodiments, the monomers have the formulae:

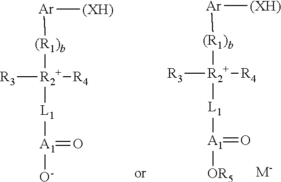

wherein

Ar is selected from arylene, substituted arylene, heteroarylene, substituted heteroarylene, alkenylene, substituted alkenylene, and alkynylene,

X is selected from S, O, NH, —C≡C—, and C6-C12 arylene,

R₁ is C1-C6 alkylene,

b is 0 or 1,

R₂ is a cationic center (e.g., ammonium, imidazolium, triazolium, pyridinium, and morpholinium),

R₃, R₄, and R₅ are independently selected from the group consisting of hydrogen, C1-C6 alkyl, substituted C1-C6 alkyl (e.g., trifluoromethyl), C6-C12 aryl, and substituted C6-C12 aryl,

L₁ is —(CH₂)ₓ—, where x is an integer from 1 to 20,

A₁ is C, S, SO, P, or PO⁻, and

M is a counter ion (e.g., Cl, Br, I, SO₄, NO₃, ClO₄, BF₄, PF₆, N(SO₂CF₃)₂, SO₃CF₃, RCOO (where R is C1-C20 alkyl), lactate, benzoate, salicylate, or derivatives thereof).

In one embodiment, the monomer has the formula:

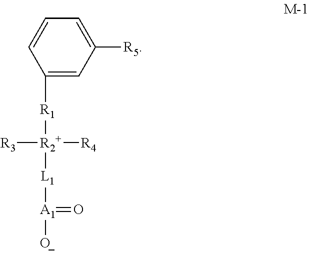

In another embodiment, the monomer has the formula:

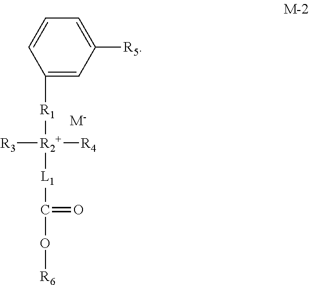

In a further embodiment, the monomer has the formula:

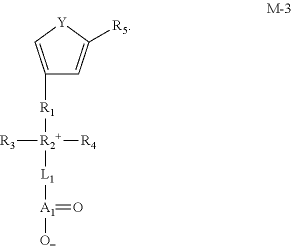

In another embodiment, the monomer has the formula:

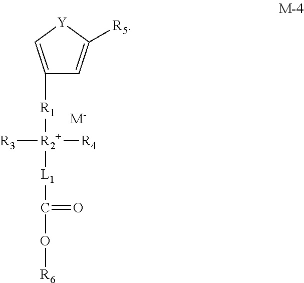

In another embodiment, the monomer has the formula:

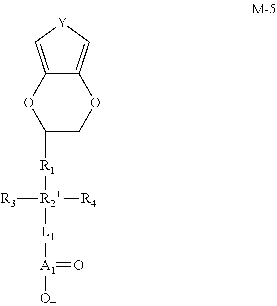

In another embodiment, the monomer has the formula:

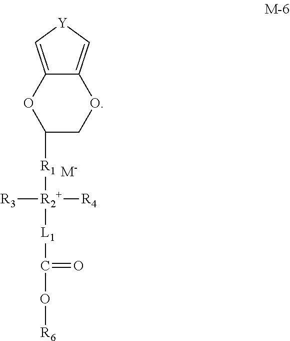

In another embodiment, the monomer has the formula:

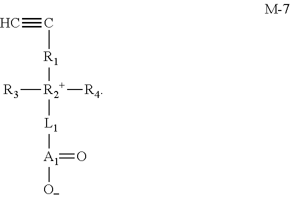

In another embodiment, the monomer has the formula:

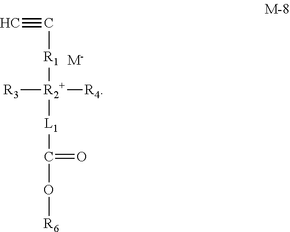

For monomers M-1-M-8,

R₁ is optional and when present is selected from R₁ is C1-C6 alkylene,

R₂ is a cationic center (e.g., ammonium, imidazolium, triazolium, pyridinium, and morpholinium),

R₃, R₄, and R₆ are independently selected from the group consisting of hydrogen, C1-C6 alkyl, substituted C1-C6 alkyl (e.g., trifluoromethyl), C6-C12 aryl, and substituted C6-C12 aryl,

L₁ is —(CH₂)ₓ—, where x is an integer from 1 to 20,

A₁ is selected from C, S, SO, P, and PO⁻,

M is a counter ion (e.g., Cl, Br, I, SO₄, NO₃, ClO₄, BF₄, PF₆, N(SO₂CF₃)₂, SO₃CF₃, RCOO (where R is C1-C20 alkyl), lactate, benzoate, salicylate, or derivatives thereof),

Y is selected from NH, S, O, and NR₇, where R₇ is selected from the group consisting of hydrogen, trifluoromethyl, C1-C6 alkyl, and C6-C12 aryl groups; and

R₅ is selected from SH, OH, NH₂, —C≡CH, and C6-C12 arylene.

As used herein, the term “substituted” refers to the replacing of a hydrogen atom with a substituent other than H. Suitable alkyl or alkylene group substituents include halo, hydroxy, amino, and C1-C6 alkoxy groups. Suitable alkenyl or alkenylene group substituents include C1-C12 alkyl, halo, hydroxy, amino, and C1-C6 alkoxy groups. Suitable aryl or arylene group substituents include C1-C12 alkyl, halo, hydroxy, amino, and C1-C6 alkoxy groups. Suitable heteroaryl or heteroarylene group substituents include C1-C12 alkyl, halo, hydroxy, amino, and C1-C6 alkoxy groups.

Self-Doping Zwitterionic Polymers

Charge transfer doping and the associated changes in the electronic properties of conjugated organic polymers, such as polyacetylene, polythiophene and polypyrrole, are well known. In such systems, the injection of charge into the delocalized π-electron system (either chemically or electrochemically) requires that dopants or counterions diffuse into the polymer during the charge injection process in order to maintain charge neutrality. In the case of polyaniline, doping can be achieved without electron transfer by protonation of the polymer. In this case, however, the doping process requires (and is limited by) the diffusion of counterions into the structure to preserve charge neutrality. This reversible exchange in large anions between the active polymer mass and the electrolyte limits many important characteristics, such as electrochromic switching and charging rates.

In a further aspect of the invention, a self-doping zwitterionic polyaniline (PANI-CB) is provided. As shown below, the ionizable functional group, dimethylglycine (—CH₂—NH⁺(CH₃)—CH₂CO₂—), is attached directly to the aromatic rings of the polymer backbone.

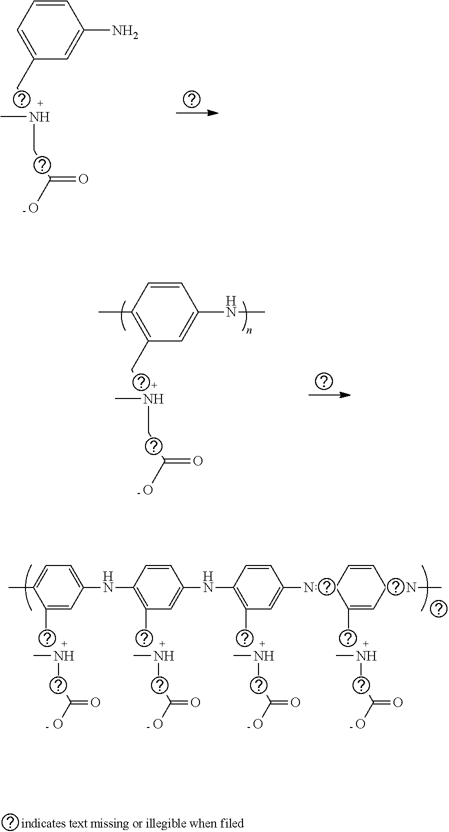

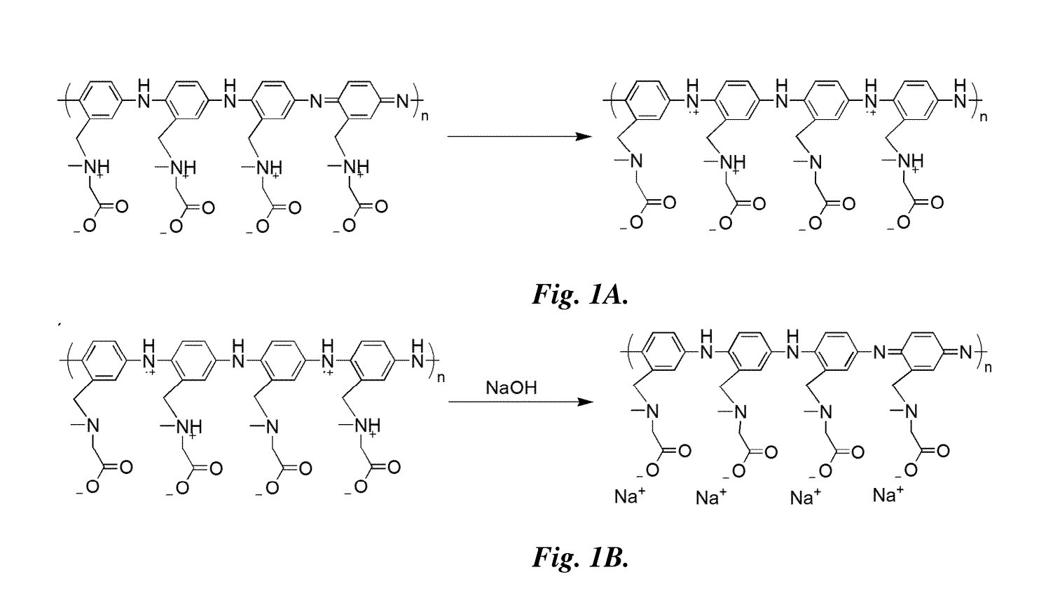

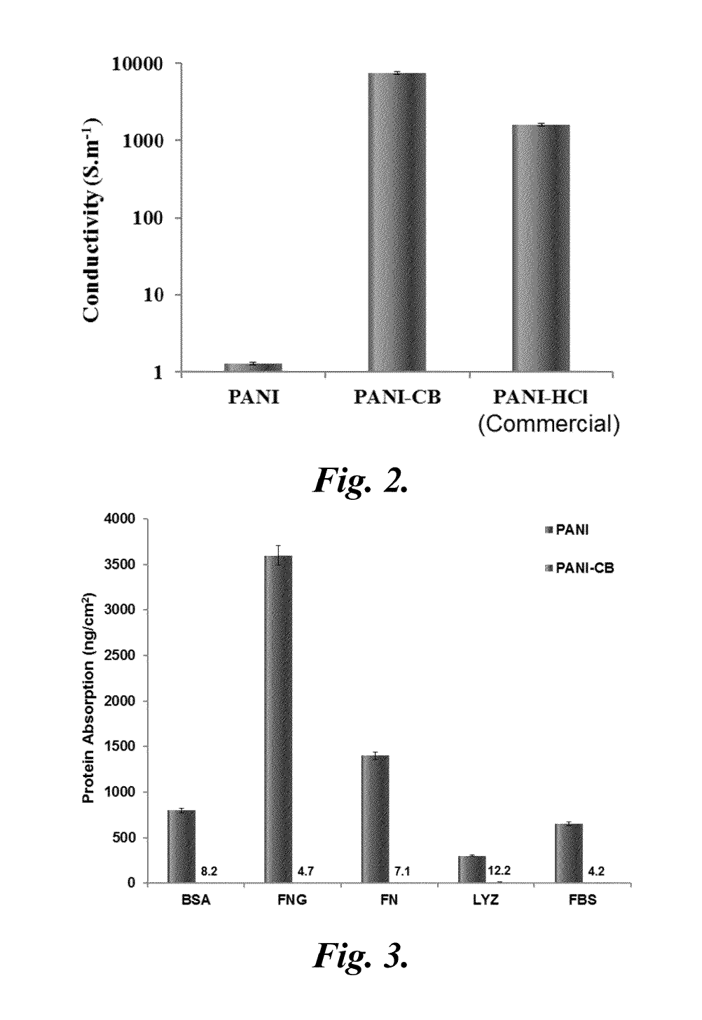

PANI-CB exhibits zwitterionic properties below pH 7.4 in aqueous solutions. (FIGS. 1A and 1B illustrate self-p-doping of PANI-CB (1A) and dedoping (1B). Under these conditions, the protonated tertiary amine of the pendant groups can further dope the backbone and the system remains electronic neutrality. As a result, the polymer exhibited high conductivity without requiring additional dopant. FIG. 2 compares conductivity of three polymers: PANI, HCl-doped PANI, and PANI-CB, a representative polymer of the invention). Moreover, due to its electronic nature, PANI-CB strongly resists protein adsorption at pH 7.4. FIG. 3 compares protein adsorption on surfaces treated with PANI and PANI-CBI (bovine serum albumin (BSA), fibrinogen (FNG), fibronectin (FN), lysozyme (LYZ) and 10% fetal bovine serum (FBS)).

PANI-CB can be further functionalized with peptide Ile-Lys-Val-Ala-Val (IKVAV), one of the active sites in laminin, for neuron adhesion and neurite outgrowth. The functionalized PANI-CB can be specifically used as a platform for the differentiation of neural stem cell and the growth of neuron while preventing the adhesion of other tissue cells.

The following examples are provided for the purpose of illustrating, not limiting, the invention.

### EXAMPLES

### Example 1

### The Preparation of Representative Zwitterionic Conducting Homopolymers

This example describes the preparation of two representative zwitterionic conducting homopolymers prepared from of zwitterionic monomers or hydrolysable precursors of zwitterionic monomers.

### 3-((3-Aminophenyl)dimethylammonio)propanoate (CBAN) monomer

N′,N′-dimethylbenzene-1,3-diamine was dissolved in methanol and reacted with di-tert-butyl dicarbonate (Boc) at the presence of triethylamine. The product was extracted by water/ethyl acetate system and then further reacted with β-propiolactone in methylene chloride. The product was precipitated by ether. Then, trifluoroacetic acid (TFA) was used to remove the Boc group and the final product was neutralized with basic resin and lyophilized.

The preparation of the CBAN monomer described above is illustrated schematically below.

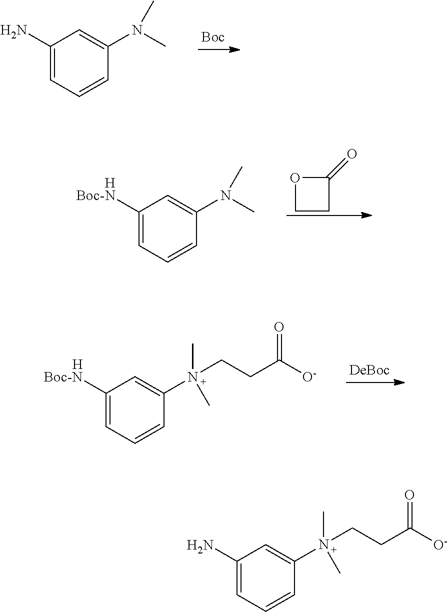

### 3-Amino-N-(3-tert-butoxy-3-oxopropyl)-N,N-dimethylbenzenaminium bromide (CBANT) monomer

N′,N′-Dimethylbenzene-1,3-diamine was dissolved in methanol and reacted with di-tert-butyl dicarbonate (Boc) at the presence of triethylamine. The product was extracted by water/ethyl acetate system and then further reacted with tert-butyl bromoacetate at 60° C. in acetonitrile. The product was precipitated in ether and further deprotected by basic resin in water. The final product was obtained by lyophilization.

The preparation of the CBANT monomer described above is illustrated schematically below.

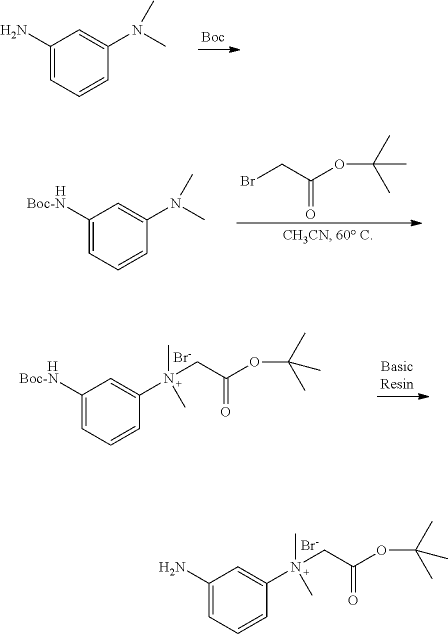

CBAN and CBANT Polymers.

The polymers were obtained by oxidative polymerization (see, e.g., Tang et al. “Polymerization of aniline under various concentrations of APS and HCl.” Polymer Journal, 43.8 (2011) 667-675). Briefly, under the protection of nitrogen gas, the monomer (CBAN or CBANT) and initiator ammonium persulfate (APS) were dissolved in water and the reaction was run for 24 hr. The polymer product was purified by dialysis and obtained by lyophilization.

The preparation of the CBAN and CBANT polymers described above is illustrated schematically below.

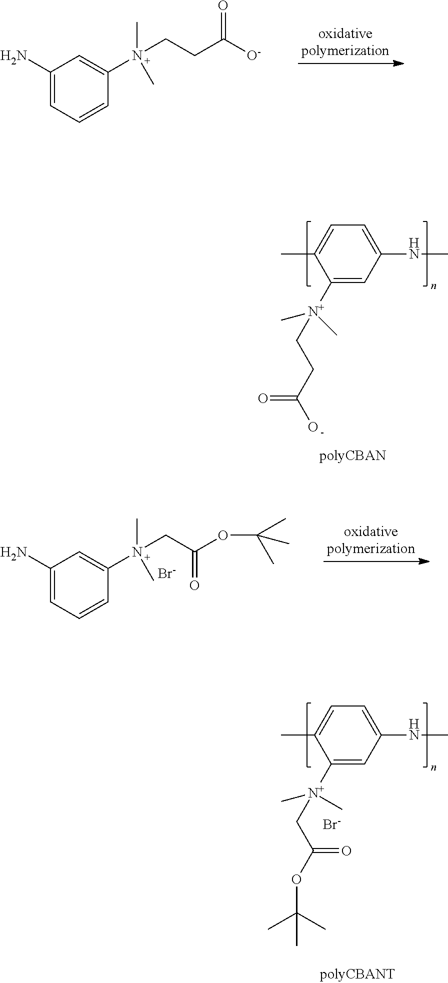

The CBANT polymer can be hydrolyzed in water to provide the corresponding zwitterionic polymer as illustrated below.

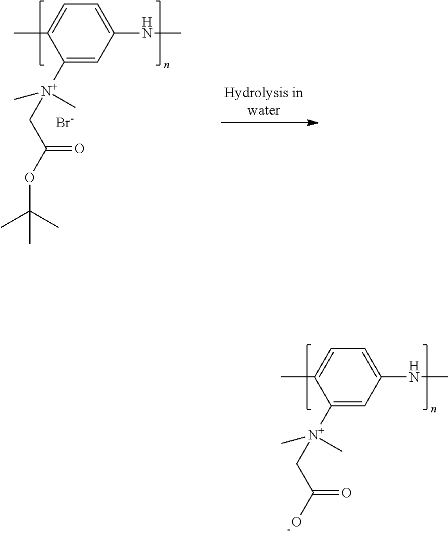

### Example 2

### The Preparation of Representative Mixed Charge Conducting Copolymer

This example describes the preparation of a representative mixed charge conducting copolymer prepared from copolymerizing the cationic monomer 3-amino-N,N,N-trimethylbenzenaminium salt with the anionic monomer 3-aminobenzoate salt or its ethyl ester, hydrolysable hydrophobic monomer ethyl 3-aminobenzoate. Oxidative polymerization was used to provide the polymers. The copolymer formed by 3-amino-N,N,N-trimethylbenzenaminium and ethyl 3-aminobenzoate can be hydrolyzed.

The preparation of the copolymers described above is illustrated schematically below.

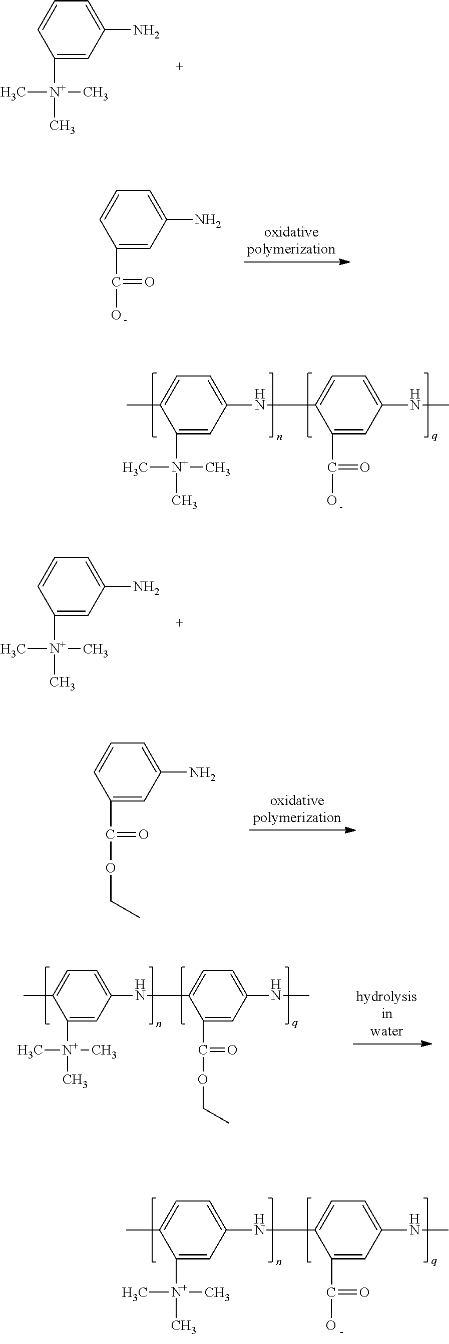

### Example 3

### The Preparation and Characteristics of a Representative Self-Doping Zwitterionic Conducting Polymer

This example describes the preparation and characteristics of a representative self-doping zwitterionic conducting polymer (PANI-CB).

Monomer Preparation

### N-Methyl-1-(3-nitrophenyl)methanamine

To a stirred suspension of 3-nitrobenzaldehyde (5 g, 33 mmol) in 50 mL heptane was added methylamine (8 mL, 40 wt. % in water, 92 mmol). The biphasic mixture was stirred at room temperature for 2 hrs and then cooled to 0° C. using ice bath. The resulting solid was filtered, rinsed with cold heptane, and dried under vacuum at 40° C. to give intermediate methyl(3-nitrobenzylidene)amine, 5.2 g, in 96% yield. 2 g (12.2 mmol) of this intermediate was dissolved in 20 mL methanol and the reaction mixture was cooled to 0° C. Sodium borohydride (0.9 g, 24.8 mmol) was then added in small aliquots and the reaction was stirred for 2 h. After completion of the reaction as monitored by TLC, the reaction was quenched with 15 mL water and extracted with 30 mL ethyl acetate. The organic layer was concentrated and purified by column chromatography to give Compound 2 (1.6 g) in 80% yield.

¹H NMR (CDCl₃, 300 MHz) δ (ppm): 8.21 (bs, 1H), 8.10 (dd, 1H), 7.60 (d, 1H), 7.50 (t, 1H), 3.86 (s, 2H), 2.47 (s, 3H).

### tert-Butyl N-methyl-N-(3-nitrobenzyl)glycinate

To a solution of compound 2 (1.6 g, 9.6 mmol) and diisopropylethyl amine (3.3 mL, 19.2 mmol) in 20 mL dichloromethane was added tert-butyl bromoacetate at room temperature. The reaction was stirred overnight. After completion of the reaction, the reaction mixture was washed with 20 mL brine. The organic contents were separated, dried by Na₂SO₄, concentrated and purified by flash chromatography to give Compound 3 in 84% yield.

¹H NMR (CDCl₃, 300 MHz) δ (ppm): 8.22 (bs, 1H), 8.10 (dd, 1H), 7.72 (d, 1H), 7.50 (t, 1H), 3.79 (s, 2H), 3.22 (s, 2H), 2.38 (s, 3H), 1.49 (s, 9H).

### N-(3-aminobenzyl)-N-methylglycine

Compound 3 (1.6 g, 5.7 mmol) was dissolved in a mixture of solvent dichloromethane (DCM):methanol (MeOH) (1:1). The reaction contents were cooled to 0° C. and then SnCl₂.2H₂O was added to it in small aliquots. The reaction mixture was stirred for 7 h until all the starting material was consumed. After completion of the reaction, saturated NaHCO₃ was added to adjust pH of the solution to between 7-8. The precipitate formed was filtered and the filtrate was concentrated. The reaction contents were then partitioned between 50 mL ethyl acetate and 20 mL water. The organic layer was separated and the aqueous layer was re-extracted with ethyl acetate. All the organic layers were combined and then purified by flash chromatography to give Compound 4 in 62% yield.

¹H NMR (MeOD, 300 MHz) δ (ppm): 6.93 (t, 1H), 6.59 (m, 2H), 6.56 (dd, 1H), 3.99 (bs, 2H), 3.38 (s, 2H), 3.13 (s, 2H), 2.61 (s, 3H).

The preparation of the monomer described above is illustrated below.

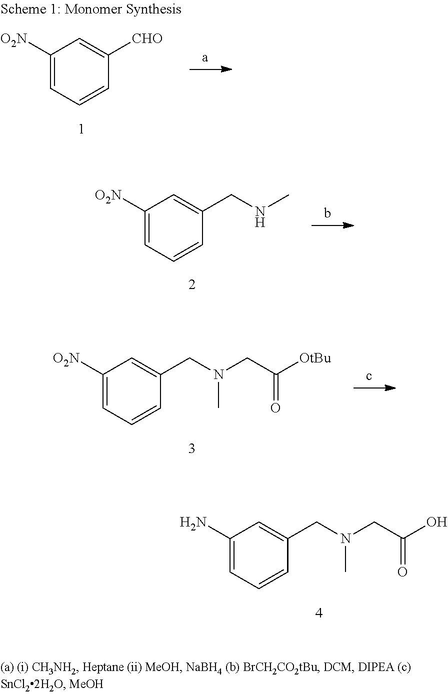 [SMILES: O=Cc1cccc([N+](=O)[O-])c1 ; CNCc1cccc([N+](=O)[O-])c1 ; CN(CC(=O)OC(C)(C)C)Cc1cccc([N+](=O)[O-])c1 ; CN(CC(=O)O)Cc1cccc(N)c1]

Electropolymerization of Zwitterionic Aniline and Electrochemical Analysis

Electrochemical experiments were performed using an Autolab PGSTAT128N potentiostat (Metrohm Autolab) and a three-electrode electrochemical cell, with a Pt electrode as the counter electrode and an Ag/AgNO₃ electrode (0.01 M AgNO₃ and 0.1 M Bu₄NPF₆ in MeCN) as the reference electrode. Each measurement was calibrated using a standard ferrocene/ferrocenium redox system.

The monomer used in this electropolymerization was Compound 4 (AN-CB).

AN-CB is highly hydrophilic, but was dissolved in organic electrolytes with the aid of the surfactant dioctyl sodium sulfosuccinate (DSS). AN-CB was electropolymerized onto conducting substrates as thin films under electrooxidation. AN-CB was electropolymerized on gold chips from 0.01 M solutions in acetonitrile containing 0.05 M DSS and 0.1 M LiClO₄ on applying cyclic potential scans. Electrochemical impedance spectroscopy (EIS) was performed using a sinusoidal excitation signal with an excitation amplitude of 10 mV at 50 frequencies logarithmically spaced from 10 kHz to 1 Hz. The conducting polymer films for measurements were coated on fresh Au substrates (area: 1 cm²). Before recording EIS spectra, samples were conditioned in PBS buffer at 0.23 V for 60 s. EIS was registered at 25° C. in the PBS buffer with 10 mM [Fe(CN)₆]³⁻/⁴⁻ (1:1, mol/mol) as the redox couple.

As shown in FIG. 1A, the protonated tertiary amine on the side chain of PANI-CB can protonate the backbone upon oxidation under pH 7.4. This self-doping process can significantly increase the conductivity of PANI-CB without the need for adding independent dopant. In addition, the dedoping process can occur in basic solutions and significantly decrease the conductivity of the PANI-CB (see FIG. 1B).

Conductivity

The conductivity of obtained chips prepared as described above was measured by a four-terminal sensing method. The conductivity of dedoped-PANI, self-doped PANI-CB, and HCl-doped PANI is compared in FIG. 2. The process occurs rapidly and can be used for electrochromic switching applications.

Protein Adsorption

A custom-built surface plasmon resonance (SPR) sensor from the Institute of Photonics and Electronics, Academy Sciences (Prague, Czech Republic) was used to determine protein adsorption to treated surfaces (W. Yang, H. Xue, W. Li, J. Zhang, and S. Jiang, Pursuing “Zero” Protein Adsorption of Poly(carboxybetaine) from Undiluted Blood Serum and Plasma, Langmuir, 25, 11911 (2009). A prepared chip was attached to the base of the prism and optical contact was established using refractive index matching fluid (Cargille). A quadruple-channel flow cell with four independent parallel flow channels was used to contain liquid samples during experiments. A peristaltic pump (Ismatec) was utilized to deliver liquid samples to the four channels of the flow cell. A stable baseline was first established with PBS solution with different concentrations of running buffer, then protein solutions including bovine serum albumin (BSA), fibrinogen (FNG), fibronectin (FN), lysozyme (LYZ) and 10% fetal bovine serum (FBS) were delivered to the surface at a flow rate of 0.050 mL/min for 30 min, and the same buffer flowed again for 10 min before determining final wavelength shifts. The concentration of the protein solutions was 1.0 mg/mL and the experiment was conducted at room temperature (about 23° C.). A surface-sensitive SPR detector was used to monitor surface interactions in real time, and wavelength shift was used as an indication of changes on the surface. As shown in FIG. 3, in contrast to the highly fouling performance of the PANI treated surface, protein adsorption on PANI-CB surface was very low (barely visible in FIG. 3).

While illustrative embodiments have been illustrated and described, it will be appreciated that various changes can be made therein without departing from the spirit and scope of the invention.

1. A polymer having repeating units, the repeating units comprising a repeating unit selected from 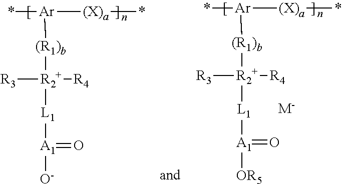
wherein
* is the point of attachment of one repeating unit and the next,
—[Ar—(X)ₐ]ₙ— forms the polymer backbone,
Ar is selected from arylene, substituted arylene, heteroarylene, substituted heteroarylene, alkenylene, substituted alkenylene, and alkynylene,
X is selected from S, O, N, NH, CH═CH, and C6-C12 arylene,
a is 0 or 1,
b is 0 or 1,
n is an integer from 5 to about 10,000,
R₁ is C1-C6 substituted or unsubstituted alkylene,
R₂ is a cationic site,
R₃, R₄, and R₅ are independently selected from the group consisting of hydrogen, C1-C6 alkyl, substituted C1-C6 alkyl, C6-C12 aryl, and substituted C6-C12 aryl,
L₁ is —(CH₂)ₓ—, where x is an integer from 1 to 20,
A₁ is C, S, SO, P, or PO⁻, and
M is a counter ion.

2. The polymer of claim 1, wherein a is 1 and X is NH.

3. The polymer of claim 1, wherein b is 0.

4. The polymer of claim 1, wherein b is 1 and R₁ is methylene.

5. The polymer of claim 1, wherein the cationic site is selected from the group consisting of ammonium, imidazolium, triazolium, pyridinium, and morpholinium.

6. The polymer of claim 1, wherein x is 1-5.

7. The polymer of claim 1, wherein A₁ is C.

8. The polymer of claim 1, wherein R₂, R₃, and R₄ taken together are selected from the group consisting of —NH₂⁺—, —NH(CH₃)⁺— and —N(CH₃)₂⁺—.

9. A polymer having repeating units, the repeating units comprising a repeating unit selected from 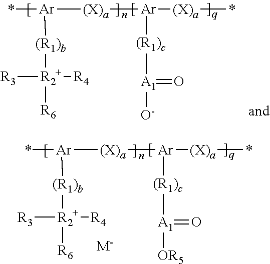
wherein
* is the point of attachment of one repeating unit and the next,
—[Ar—(X)ₐ]ₙ— forms the polymer backbone,
Ar is selected from arylene, substituted arylene, heteroarylene, substituted heteroarylene, alkenylene, substituted alkenylene, and alkynylene,
X is selected from S, O, N, NH, CH═CH, and C6-C12 arylene,
a is 0 or 1,
b is 0 or 1,
c is 0 or 1,
n is an integer from 5 to about 10,000,
q is an integer from 5 to about 10,000,
R₁ at each occurrence is selected from C1-C6 substituted or unsubstituted alkylene,
R₂ is a cationic site,
R₃, R₄, R₅, and R₆ are independently selected from the group consisting of hydrogen, C1-C6 alkyl, substituted C1-C6 alkyl, C6-C12 aryl, and substituted C6-C12 aryl,
A₁ is C, S, SO, P, or PO⁻, and
M is a counterion.

10-17. (canceled)

18. A modified surface comprising a polymer of claim 1.

19. The surface of claim 18, wherein the surface is the surface of a medical, electronic, or marine device.

20. The surface of claim 18, wherein the surface is the surface of artificial neural system, neuron-regeneration platform, neural sensor, cell-culture platform; non-fouling semi-conductor, battery, organic solar cell, biofuel cell, printed electronic circuit, organic light-emitting diode, actuator, electrochromism device, supercapacitor, chemical sensor, flexible transparent display, electromagnetic shield, antistatic coating, microwave-absorbent device, or radar-absorptive device.

21-23. (canceled)

24. A compound having the formula: 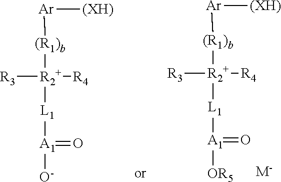
wherein
Ar is selected from arylene, substituted arylene, heteroarylene, substituted heteroarylene, alkenylene, substituted alkenylene, and alkynylene,
X is selected from S, O, NH, —C≡C—, and C6-C12 arylene,
R₁ is C1-C6 alkylene,
b is 0 or 1,
R₂ is a cationic center,
R₃, R₄, and R₅ are independently selected from the group consisting of hydrogen, C1-C6 alkyl, substituted C1-C6 alkyl, C6-C12 aryl, and substituted C6-C12 aryl,
L₁ is —(CH₂)ₓ—, where x is an integer from 1 to 20,
A₁ is C, S, SO, P, or PO⁻, and
M is a counter ion.

25. The compound of claim 24, wherein a is 1 and X is NH.

26. The compound of claim 24, wherein b is 0.

27. The compound of claim 24, wherein b is 1 and R₁ is methylene.

28. The compound of claim 24, wherein the cationic site is selected from the group consisting of ammonium, imidazolium, triazolium, pyridinium, and morpholinium.

29. The compound of claim 24, wherein x is 1-5.

30. The compound of claim 24, wherein A₁ is C.

31. The compound of claim 24, wherein R₂, R₃, and R₄ taken together are selected from the group consisting of —NH₂⁺—, —NH(CH₃)⁺— and —N(CH₃)₂⁺—.

32-35. (canceled)
